(19) United States
(12) Patent Application Publication
(10) Pub. No.: US 2025/0222730 A1
(43) Pub. Date: Jul. 10, 2025

(54) TRAILER HITCH STABILIZING DEVICES

(71) Applicant: Kent HERMAN, Bend, OR (US)

(72) Inventor: Kent HERMAN, Bend, OR (US)

(21) Appl. No.: 18/405,627

(22) Filed: Jan. 5, 2024

(51) Int. Cl. B60D 1/30

(52) U.S. Cl. CPC B60D 1/30

(57) ABSTRACT

Devices are disclosed that are configured for preventing relative movement of a mounting tube within a trailer hitch receiver tube. Some devices include a plate member having a planar portion and an angled portion, the planar portion including an aperture configured to receive the mounting tube and the angled portion including a threaded aperture; and a threaded fastener disposed in the threaded aperture. Method of using the devices are also disclosed.

### BACKGROUND

Trailer hitches generally include a receiver hitch or receiver tube that is bolted onto the underside or rear side of a vehicle to provide a tube for attaching a ball mount or other hitch accessory having a mounting tube configured to slide into the receiver tube. The mounting tube includes a pair of aligned holes near its distal end and the receiver tube includes a corresponding pair of holes. A user aligns the holes in the mounting tube with those in the receiver tube by sliding the mounting tube into the receiver tube a correct distance, and inserts a hitch pin through the aligned holes to secure the mounting tube in place within the receiver tube.

Because clearance between outer walls of the mounting tube and inner walls of the receiver tube must be provided in order to facilitate insertion of the mounting tube into the receiver tube, the mounting tube will generally rattle within the receiver tube, making noise that is annoying to the user and over extended periods of time causing wear to the parts. The pin also tends to vibrate in the aligned through holes, causing additional rattling and potential damage to the pin from the long term impact from the edges of the through holes that can be caused by repetitive relative movement of the mounting tube relative to the receiver tube.

### SUMMARY

The present disclosure features trailer hitch stabilizing devices that apply a force to the receiver tube of the hitch to reduce movement of the mounting tube within the receiver tube.

In one aspect, the present disclosure features a device for preventing relative movement of a mounting tube within a trailer hitch receiver tube, the device comprising: (a) a plate member having a planar portion and an angled portion, the planar portion including an aperture configured to receive the mounting tube and the angled portion including a threaded aperture; and (b) a threaded fastener disposed in the threaded aperture.

Some implementations may include one or more of the following features. The angled portion may be disposed at an angle of about 0 to 45 degrees, e.g., from about 35 to 45 degrees, with respect to the planar portion. The aperture may be configured to receive the mounting tube and is configured to surround the mounting tube with a clearance of from about 0.007 to 0.25 inch, e.g., 0.008 to 0.05 inch, between a peripheral edge of the aperture and an outer surface of the mounting tube. The aperture may be square. A longitudinal axis of the threaded fastener may be disposed at an angle of from about 100 to 160 degrees, e.g., about 120 to 140 degrees, with respect to a planar surface of the planar portion. The plate member is formed of a sheet material. The sheet material may have a thickness of from about 0.125 to 0.5 inch, e.g., from about 0.25 to 0.5 inch. The threaded fastener may have a diameter of about 0.25 to 0.5 inch. The threaded aperture of the plate member may include at least three threads.

In another aspect, the invention features a method of stabilizing a trailer hitch, the method comprising: (1) providing a device comprising (a) a plate member having a planar portion and an angled portion, the planar portion including an aperture configured to receive a mounting tube and the angled portion including a threaded aperture; and (b) a threaded fastener disposed in the threaded aperture; (2) sliding the device onto a mounting tube such that the mounting tube extends through the aperture in the planar portion; (3) sliding the mounting tube into a receiver tube of a trailer hitch; (4) positioning the plate member adjacent to but not touching a distal end of the receiver tube; and (5) threading the threaded fastener into the threaded aperture until a distal end of the threaded fastener contacts and applies pressure to a corner of the distal end of the receiver tube.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### DESCRIPTION OF THE DRAWINGS

FIG. 1 is a perspective view of a hitch stabilizing device according to one implementation taken from one side of the device.

FIG. 1A is similar to FIG. 1 but is taken from an opposite side of the device.

FIG. 2 is a perspective view of the plate member of the hitch stabilizing device of FIG. 1 in isolation, taken from the same viewpoint as FIG. 1.

FIG. 2A is similar to FIG. 2 but is taken from the same viewpoint as FIG. 1A.

FIG. 3 is a perspective view of the device of FIGS. 1-2A in position on a mounting tube of a trailer hitch, with the threaded fastener of the device retracted.

FIG. 4 is a perspective view of the device fully installed on the trailer hitch, with the threaded fastener extended to engage a flange of the receiver tube of the trailer hitch.

FIG. 5 is a side cross-sectional tube of the plate member shown in FIGS. 2-2A.

FIG. 5A is a side cross-sectional view of the plate member with the threaded fastener in place in the threaded aperture.

FIG. 6 is a perspective view of a device according to another implementation installed on a trailer hitch.

FIG. 7 is a perspective view of a device according to yet another implementation installed on a trailer hitch.

### DETAILED DESCRIPTION

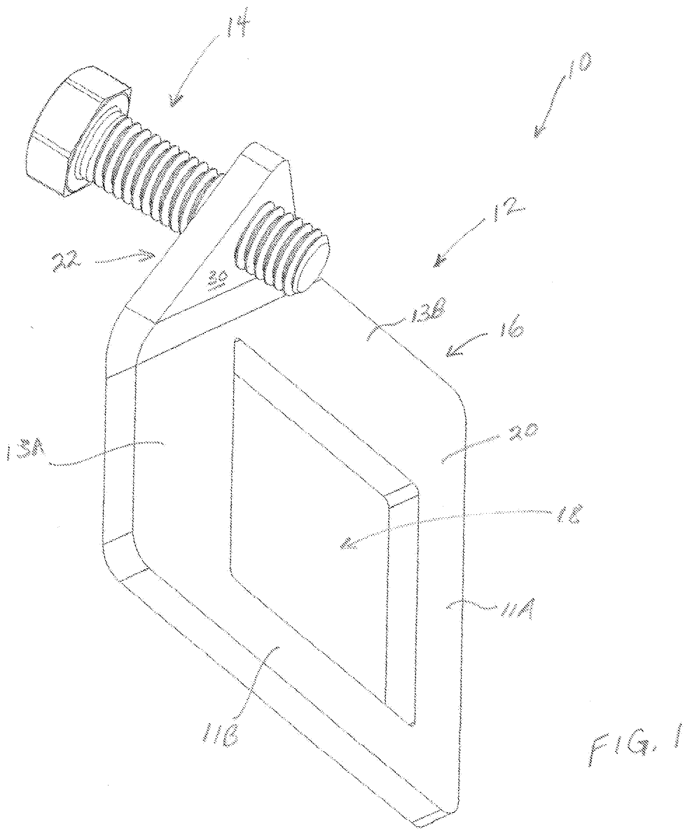

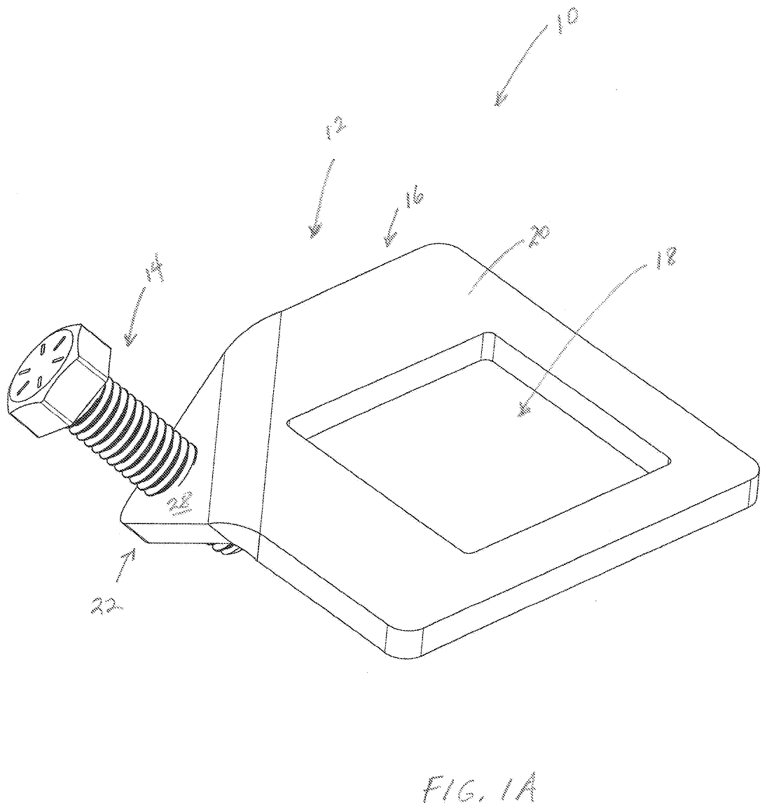

FIGS. 1 and 1A show a hitch stabilizing device 10 according to one implementation. Stabilizing device 10 includes a plate member 12 and a threaded fastener 14. The plate member 12 includes a generally planar portion 16 having a generally square aperture 18 surrounded by a frame 20. The plate member 12 is generally square, with the aperture 18 offset from the center of the plate such that two sides 11A and 11B of the frame 20 are narrower, for example approximately half as wide, as the two diagonally opposite sides 13A and 13B.

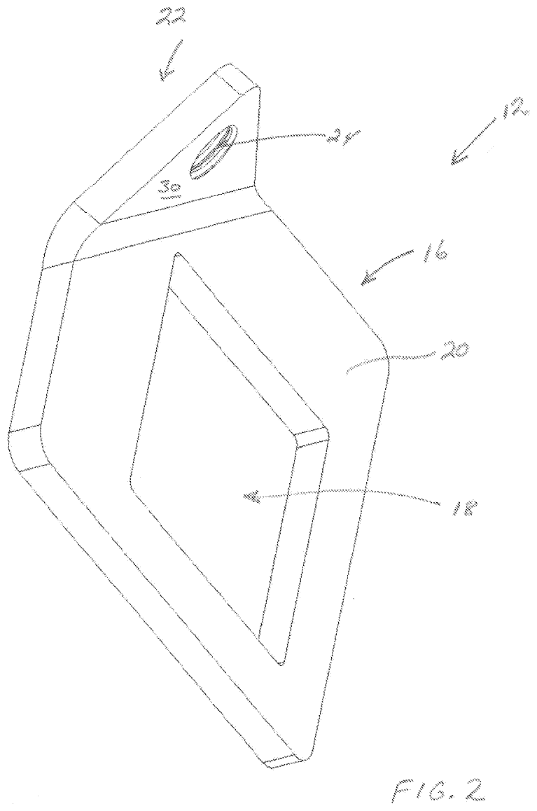

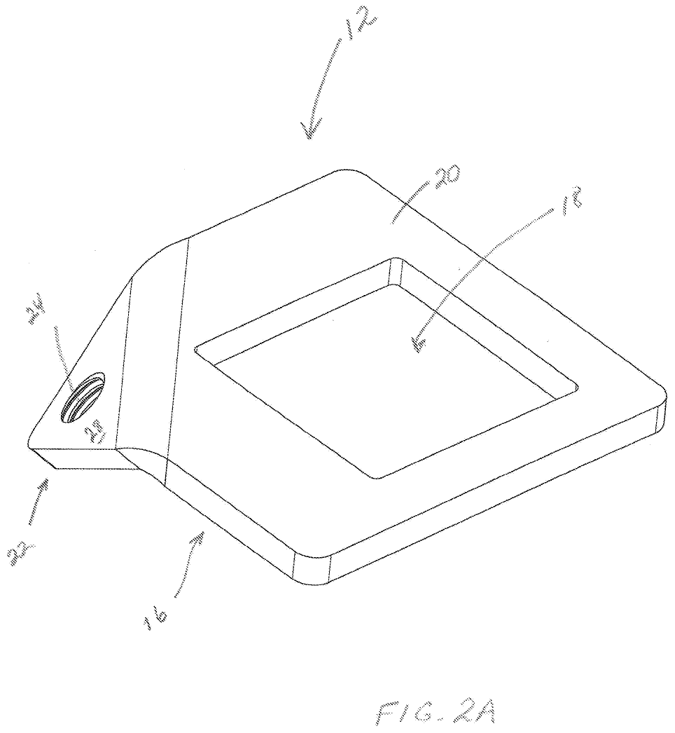

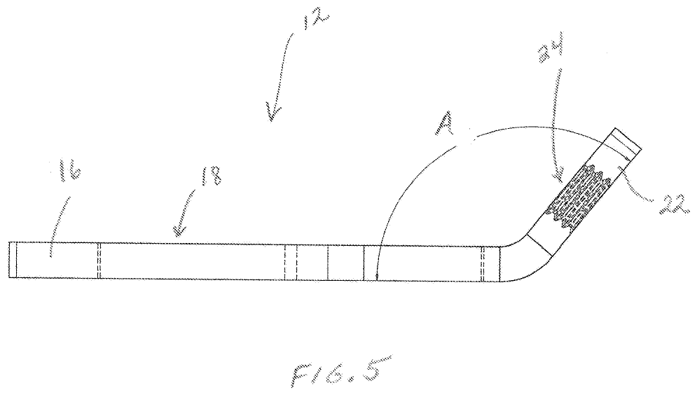

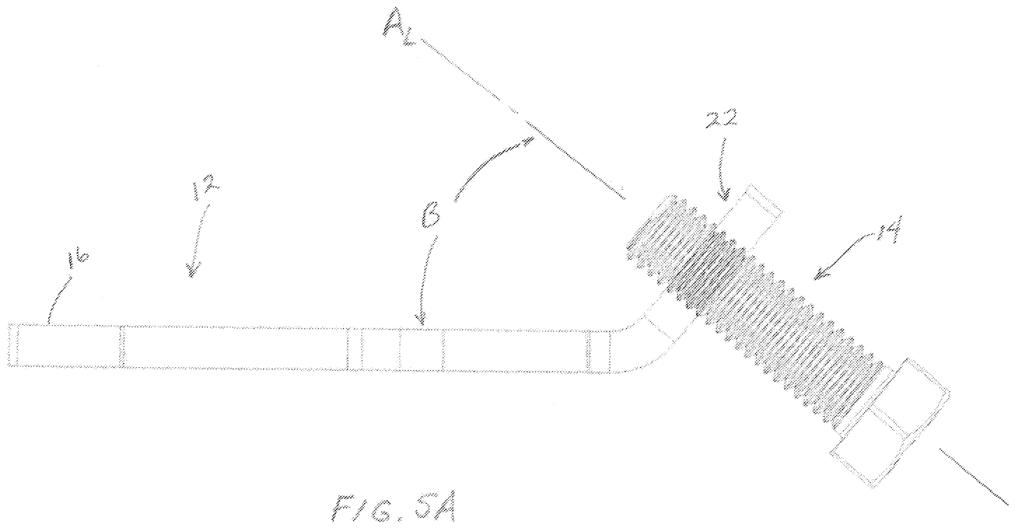

A generally triangular angled portion 22 extends at an angle A from the planar portion 16 (see FIG. 5) at the corner of the wider frame sides 13A and 13B. As can be seen in FIGS. 2 and 2A, the triangular portion 22 includes a threaded aperture 24. Threaded aperture 24 may be part of the sheet, as shown, or may be formed by welding a nut or other threaded element onto the sheet.

Referring again to FIGS. 1 and 1A, in use a threaded fastener 26 is threaded through the aperture 24 from the back surface 28 (FIGS. 1A and 2A) to the front surface 30 (FIGS. 1 and 2) of the triangular portion 22 such that the longitudinal axis A_{L} of the threaded fastener extends at an angle of from about 20 to 50 degrees, e.g., about 25 to 45 degrees, (angle B, FIG. 5A) with respect to the upper surface of planar portion 16. The threaded fastener is preferably sized to have sufficient strength to resist bending, stripping, or other damage in use. In some implementations the threaded fastener has a diameter of from about 0.25″ to 0.5″.

In use, the hitch stabilizing device 10 is installed by first sliding the plate member 12 onto a mounting tube 30 of a trailer hitch such that the mounting tube 30 extends through the aperture 18 (FIG. 1) in the plate member 12. The aperture 18 is sized to receive the mounting tube 30 with very little clearance between the edges of the aperture 18 and the outer surface 31 of the mounting tube. The clearance should be just sufficient to allow a user to easily slide the plate member onto the mounting tube. For example, the clearance may be about 0.007 to 0.25 inch, e.g., 0.008 to 0.05 inch.

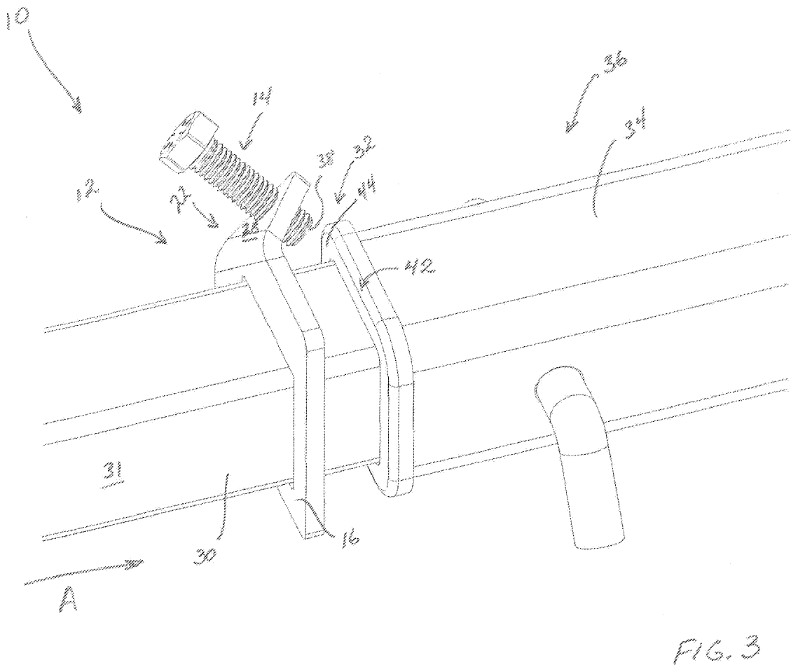

As shown in FIG. 3, the user then slides the mounting tube 30 into a receiver tube 34 of a trailer hitch 36 in the direction indicated by arrow A. The user positions device 10 near the distal end 32 of the receiver tube 34 but spaced sufficiently from the distal end 32 that the device 10 does not contact the receiver tube.

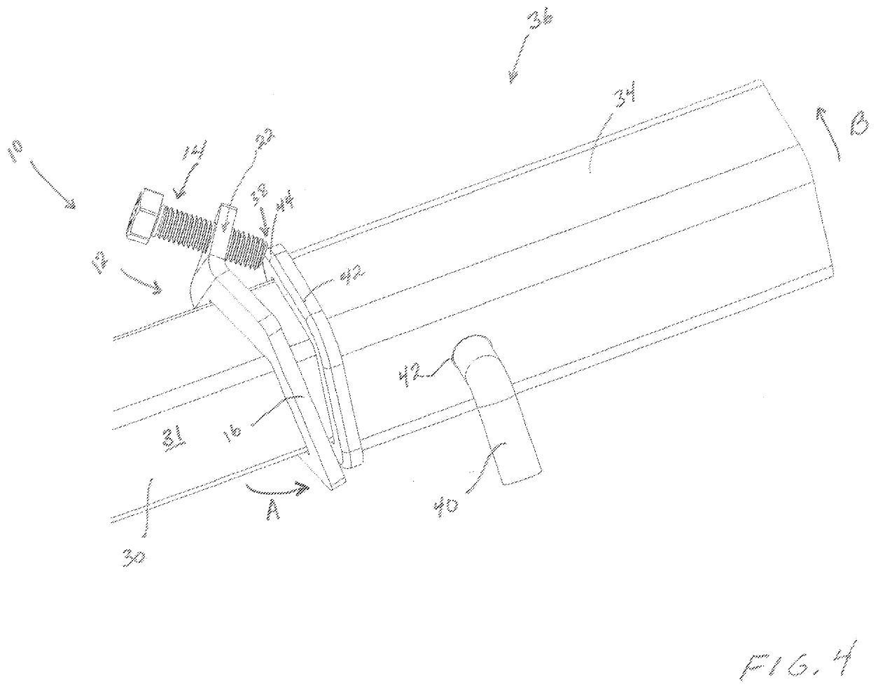

In the next step of the installation, shown in FIG. 4, the threaded fastener 14 is advanced until the distal end 38 of the fastener 14 contacts a corner 44 of flange 42 of the receiver tube 34. The user then continues to tighten the fastener against the flange until the user is unable to move the mounting tube within the receiver tube.

Because the distal end of the fastener contacts the flange 42 at its corner 44 and the fastener extends from the plate member 12 at an angle due to it being mounted in the angled triangular portion 22, the fastener applies a diagonal force to the flange. The opposing force provided by the flange 42 causes the plate member 12 to pivot, with the opposite corner of the plate being displaced as indicated by arrow A in FIG. 4. The pivoted plate member 12 applies a force to the mounting tube 30 which it surrounds, causing the mounting tube 30 to move diagonally within the receiver tube 34 in the direction indicated by arrow B in FIG. 4. This diagonal movement forces one side of the end of the mounting tube 30 against the inner wall (not shown) of the receiver tube 34, a position in which the mounting tube cannot rattle relative to the receiver tube.

The diagonal movement of the mounting tube 30 also forces the pair of holes (not shown) in the mounting tube 30 through which the hitch pin 40 passes to become slightly misaligned with the corresponding holes 42 in the receiver tube 34. This misalignment holds the hitch pin 40 firmly in place, preventing rattling of the pin.

The angle A (FIG. 5) of the triangular portion 22 relative to the planar portion 16 is important because the triangular portion supports the fastener 14 and thus the angle of the triangular portion 22 determines the angle at which the fastener 14 is positioned relative to the flange 42 of the receiver tube (see FIG. 4). This positioning is designed to cause the distal end 38 of the fastener 14 to be oriented to contact the corner 44 rather than some other area of the flange 42. Pressure being applied by the threaded fastener 14 (and thus indirectly by a corner of the plate member 12) directly to the corner 44 of the flange is important to producing the diagonal force discussed above. The angle A of the triangular portion 22 is selected to provide this contact between the fastener and the corner. Preferably, the angle A (FIG. 5) is from about 100 to 160 degrees, more preferably from about 120 to 140 degrees.

It is noted that when the plate member 12 is in the rotated position shown in FIG. 4 the corner of the plate member 12 diagonally opposite the triangular portion 22 does not contact the flange 42. If the geometry of the device were such that this corner of the plate member were in contact with the flange this would inhibit the ability of the device to generate the force needed to prevent movement of the mounting tube in the receiver tube.

The triangular portion of the plate member 12 may be formed, for example, by providing a flat sheet of steel or other metal and bending one corner up. In this case, the sheet metal should be sufficiently thick to be bent in this manner and to hold the bend. In some implementations the sheet material has a thickness of 0.125 to 0.5 inch, for example from about 0.25 to 0.5 inch. The sheet material should also generally be of sufficient thickness to form at least two and preferably at least three threads in the threaded aperture 24 to hold the bolt securely without stripping. The sheet material should also be sufficiently thick and strong to withstand the applied forces without distortion and to be used repeatedly and/or for long periods of time without fatiguing. In some implementations the sheet material is corrosion resistant.

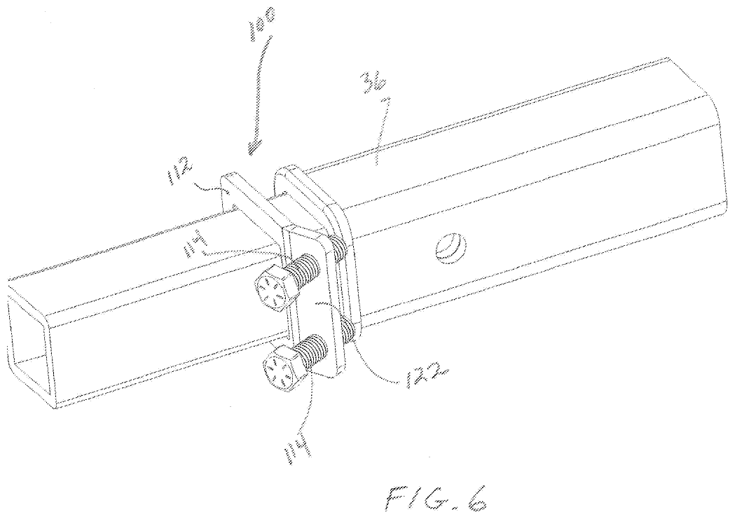

As shown in FIG. 6, in another embodiment a device 100 includes a plate 112 having a rectangular angled portion 122 rather than a triangular angled portion. In this embodiment a pair of threaded fasteners 114 extend through a pair of threaded apertures in portion 122. The distal ends of the fasteners 114 contact the flange of the receiver tube 34 and press against the flange in the same manner as described above, but along the length of the flange rather than at a corner. The threaded fasteners extend at an angle with respect to the plate 112 and to the flange of the receiver tube 34, and thus apply a stabilizing force that pivots the accessory tube with respect to the receiver tube in a manner similar to that described above with regard to the device 10.

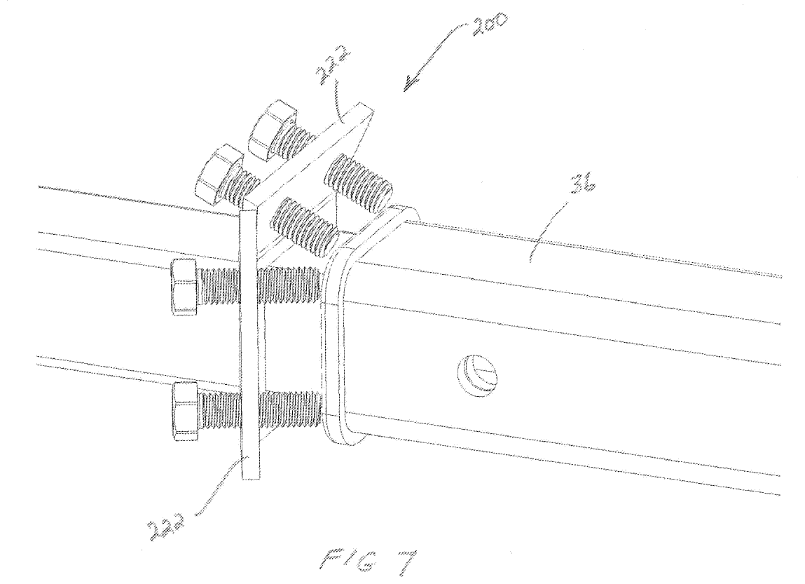

Referring to FIG. 7, in a further embodiment a device 200 includes two angled portions 222, each including a pair of threaded apertures that receive a pair of threaded fasteners. In this embodiment stabilizing force can be applied to both the top and one side of the flange of the receiver tube for added stabilization.

### Other Embodiments

A number of embodiments have been described. Nevertheless, it will be understood that various modifications may be made without departing from the spirit and scope of the disclosure.

For example, while it is convenient that the triangular portion 22 be triangular, as this allows it to be formed by bending a corner of a square or rectangular plate, if desired the triangular portion can have a different shape, e.g., its apex can be radiused. Moreover, as described above with reference to FIGS. 6 and 7, the angled portion of the plate may be rectangular, in which case it may be formed by bending up an edge of the plate. Also, while the plate is shown as generally rectangular a square plate may be used if desired.

In addition, in some implementations a nut (not shown) is threaded between the head of the threaded fastener and the opposed surface of the plate member. The nut is tightened by the user against the surface of the plate member and can help keep pressure on the bolt and keep it from rattling loose.

In some applications the receiver tube of the receiver hitch does not have a flange. In such situations the distal end(s) of the fastener(s) contact the distal end of the receiver tube rather than a flange as discussed above.

Accordingly, other embodiments are within the scope of the following claims.

What is claimed is:

1. A device for preventing relative movement of a mounting tube within a trailer hitch receiver tube, the device comprising:
a plate member having a planar portion and an angled portion, the planar portion including an aperture configured to receive the mounting tube and the angled portion including a threaded aperture; and
a threaded fastener disposed in the threaded aperture.

2. The device of claim 1 wherein the angled portion is disposed at an angle of from about 120 to 140 degrees with respect to the planar portion.

3. The device of claim 1 wherein the aperture is configured to receive the mounting tube is configured to surround the mounting tube with a clearance of from about 0.007 to 0.25 inch between a peripheral edge of the aperture and an outer surface of the mounting tube.

4. The device of claim 1 wherein the aperture is square.

5. The device of claim 1 wherein a longitudinal axis of the threaded fastener is disposed at an angle of from about 25 to 45 degrees with respect to a planar surface of the planar portion.

6. The device of claim 1 wherein the plate member is formed of a sheet material.

7. The device of claim 6 wherein the sheet material has a thickness of about 0.125 to 0.5 inch.

8. The device of claim 7 wherein the sheet material has a thickness of from about 0.25 to 0.5 inch.

9. The device of claim 1 wherein the threaded fastener has a diameter of from about 0.25 to 0.5 inch.

10. The device of claim 1 wherein the threaded aperture includes at least three threads.

11. The device of claim 1 wherein the angled portion is triangular.

12. The device of claim 1 wherein the angled portion is rectangular.

13. The device of claim 12 wherein the angled portion includes a pair of threaded apertures.

14. A method of stabilizing a trailer hitch, the method comprising:
providing a device comprising (a) a plate member having a planar portion and an angled portion, the planar portion including an aperture configured to receive a mounting tube and the angled portion including a threaded aperture; and (b) a threaded fastener disposed in the threaded aperture;
sliding the device onto a mounting tube such that the mounting tube extends through the aperture in the planar portion;
sliding the mounting tube into a receiver tube of a trailer hitch;
positioning the plate member adjacent to but not touching a distal end of the receiver tube; and
threading the threaded fastener into the threaded aperture until a distal end of the threaded fastener contacts and applies pressure to a corner of the distal end of the receiver tube.
